(19) United States
(12) Patent Application Publication
(10) Pub. No.: US 2014/0065272 A1
(43) Pub. Date: Mar. 6, 2014

(54) NOZZLE PANEL

(71) Applicant: Jan Folkmar, Weggis (CH)

(72) Inventor: Jan Folkmar, Weggis (CH)

(21) Appl. No.: 13/600,868

(22) Filed: Aug. 31, 2012

(51) Int. Cl. A47J 47/16; A47J 47/00; B65D 25/20; B65D 47/06; A21D 13/00

(52) U.S. Cl. 426/383; 222/568; 220/200; 206/525; 248/346.5

(57) ABSTRACT

A nozzle panel for holding bakery accessories comprising a flat panel base, a plurality of panel protrusions integral with the panel base and at least one bakery accessory attachable to the panel protrusions on the panel base. The panel protrusion includes a lip engagable with a bakery nozzle. The panel protrusion lip may be an interrupted helical thread attached to the panel protrusion, at least one nozzle engagable with the panel protrusion by twisting the nozzle relative to the panel base less than 360° . The nozzle may include an inwardly extending interrupted helical thread adjacent a bottom edge of the nozzle and may be rotatably engagable with the interrupted thread of panel protrusion. The nozzle panel may include at least one container attachable to the panel protrusion. The container may be cylindrical and include an opening at one end and a removable lid engagable with the opening.

### BACKGROUND OF THE INVENTION

1. Field of the Invention

The present invention relates to a nozzle panel for holding and storing bakery accessories such as nozzles, nozzle adapters, nozzle adapter caps, small bakery containers and/or bakery brushes.

2. Description of Related Art

Some of the tools used in a bakery include those used in the creation and decoration of the baked products such as cakes and pastries. The tools include a bakery bag sleeve and nozzles which allow the baker to add decorative frosting to the baked item. The sleeve is filled with frosting, cream, filling or the like, the nozzle attached to one end of the sleeve, and the baker squeezes the sleeve to force the frosting out through the nozzle and onto or into the baked item. The process can become frustrating when matching up the bag with a nozzle where the nozzle is stored in a drawer with a number of other nozzles and bakery tools.

### SUMMARY OF THE INVENTION

Bearing in mind the problems and deficiencies of the prior art, it is therefore an object of the present invention to provide a storage panel which stores and organizes bakery products and accessories such as nozzles, nozzle adapters, nozzle adapter caps, small bakery containers and/or bakery brushes.

It is another object of the present invention to provide a storage panel and method for storing a number of different bakery accessories, which bakery accessories may be attached to and removed easily from the storage panel.

Still other objects and advantages of the invention will in part be obvious and will in part be apparent from the specification.

The above and other objects, which will be apparent to those skilled in the art, are achieved in the present invention which is directed to a nozzle panel for holding bakery accessories comprising a flat panel base, a plurality of panel protrusions integral with the panel base and at least one bakery accessory attachable to the panel protrusions on the flat panel base. The panel protrusion includes a lip engagable with a bakery accessory, for example, a nozzle.

The panel protrusion lip may be an interrupted helical thread attached to the panel protrusion whereby the at least one nozzle is engagable with the panel protrusion by twisting the nozzle relative to the panel base less than 360°. The nozzle may include an inwardly extending interrupted helical thread adjacent a bottom edge of the nozzle and may be rotatably engagable with the interrupted thread of panel protrusion. The nozzle panel may include at least one container attachable to the panel protrusion. The container may be cylindrical and include a container opening at one end of the container and a removable lid engagable with the container opening. The nozzle panel may include at least one brush clip integral with the panel base and at least one bakery brush attachable the brush clip.

The nozzle panel may include at least one nozzle adapter clip and at least one nozzle adapter attachable to the nozzle adapter clip, the nozzle adapter clip including a circular rim extending upward from the panel base and rim protrusions extending inwardly from the rim whereby the nozzle adapter clip is engagable with the nozzle adapter. The panel protrusion may be cylindrical and include a substantially flat upper surface and a cylindrical wall, the panel protrusion lip extending outwardly along the cylindrical wall adjacent the upper surface. The nozzle may include an inwardly extending interrupted helical thread adjacent a bottom edge of the nozzle and is engagable with the panel protrusion.

The panel protrusion may be cylindrical and include an upper rim and a cylindrical wall. The panel protrusion lip may extend outwardly along the cylindrical wall adjacent the upper rim. The nozzle panel may include a marking on or adjacent at least one of the panel protrusions for indicating which bakery accessory is designated for the at least one of the panel protrusions. Alternately, a marking may be on or adjacent each of the panel protrusions and nozzle clips.

The nozzle panel may include a nozzle panel cover engagable with the nozzle panel. The nozzle panel may include a lip on an edge of the nozzle panel and on an edge of the nozzle panel cover whereby the nozzle panel cover may engage the edge to the nozzle panel.

Another aspect of the present invention is directed to a nozzle panel for holding bakery nozzles comprising a flat panel base and a panel protrusion integral with the panel base. The panel protrusion may include a lip engagable with a nozzle or other bakery accessory. The nozzle panel may include a panel clip integral with the panel base, the panel clip including a circular rim extending upward from the panel base and spaced rim protrusions extending inwardly from the rim engagable with a nozzle adapter.

The panel protrusion lip may be spirally attached to the panel protrusion whereby the at least one nozzle is engagable with the panel protrusion by twisting the nozzle relative to the panel base less than 360°. The nozzle panel may include at least one container attachable to the panel protrusion. The container may be cylindrical and have a container opening at one end of the container and a removable lid engagable with the container opening.

Another aspect of the present invention is directed to a method of using a bakery accessory panel by providing a panel for holding bakery accessories, the panel having a flat panel base and a plurality of panel protrusions integral with the panel base, the panel protrusion having a lip engagable with a bakery nozzle. The method includes providing any combination of a plurality of nozzles and/or other bakery accessories selected from the group consisting of nozzles, nozzle adapters, nozzle adapter caps, bakery containers and bakery brushes. The method may include initially engaging each of the plurality of nozzles or other accessories with a panel protrusion, selecting a nozzle or other accessory to use in the preparation of food items, using the nozzle or other accessory in the preparation of the food items and engaging the nozzle or other accessory with the corresponding panel protrusion. The method may include washing and drying the nozzle or other accessory before engaging with the panel protrusion.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of the nozzle panel according to the present invention.

FIG. 2 is a perspective view of the nozzle panel, nozzles and nozzle adapters according to the present invention.

FIG. 3 is a top plan view of a portion of the nozzle panel of FIG. 1.

FIG. 4 is a perspective view of a portion of the panel of FIG. 1.

FIG. 5 is an exploded view of a nozzle and panel protrusion according to the present invention.

FIG. 6 is an exploded view of a nozzle, nozzle adapter and adapter clip according to the present invention.

FIG. 7 is a side elevational view of the nozzle, nozzle adapter and adapter clip of FIG. 6.

FIG. 8 is a side elevational view of an adapter cap according to the present invention.

FIG. 9 is an exploded view of a small bakery container and associated panel protrusion according to the present invention.

FIG. 10 is a side elevational view of the small bakery container shown in FIG. 9.

FIG. 11 is an exploded view of a second embodiment of a small bakery container and panel protrusion according to the present invention.

FIG. 12 is a side cross-sectional view of the small bakery container shown in FIG. 11.

FIG. 13 is a second embodiment of a nozzle which includes structural features.

FIG. 14 is a perspective view of a nozzle panel cover and the nozzle panel of FIG. 1.

### DESCRIPTION OF THE PREFERRED EMBODIMENT(S)

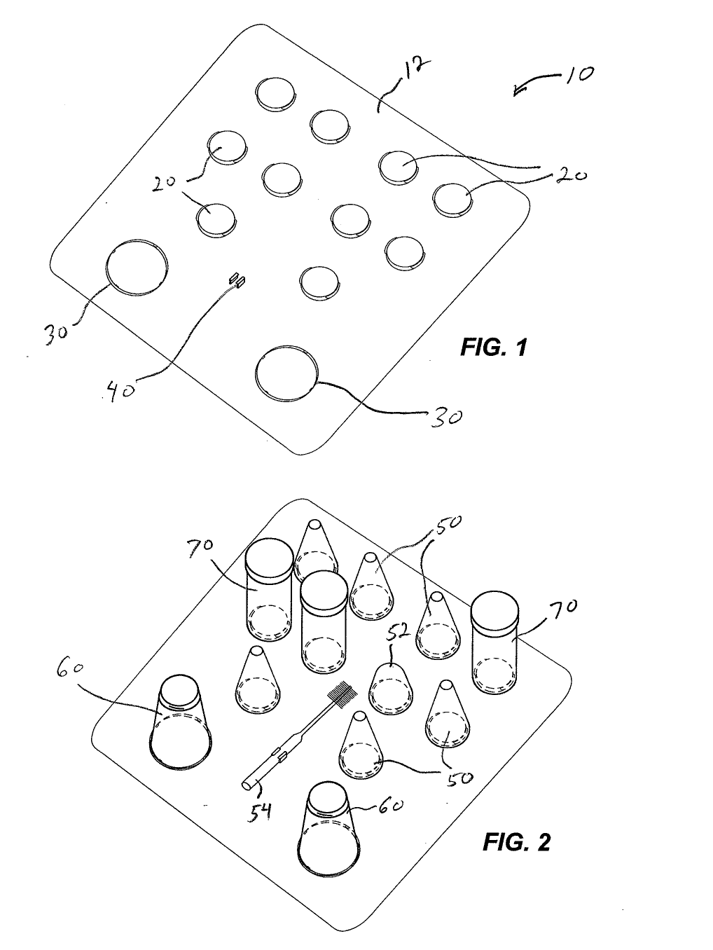

In describing the preferred embodiment of the present invention, reference will be made herein to FIGS. 1-14 of the drawings in which like numerals refer to like features of the invention.

FIGS. 1 and 2 show perspective views of a nozzle panel 10 for retaining bakery accessories. The nozzle panel 10 includes a flat panel base 12 and panel protrusions 20 integral with the panel base 12. The panel protrusions 20 retain bakery nozzles, containers or other bakery accessories to the panel 10 for storage and for easy organization and access. The nozzle panel 10 includes a nozzle adapter clip 30 and brush clip 40. Attached to the nozzle panel are nozzle 50, nozzle adapter 60, adapter cap 52, bakery brush 54 and bakery container 70. It should be understood that panel 12 may be made with other combinations of protrusions or clips, or solely with one type of protrusion or clip, and arranged in any manner, instead of the combination of protrusions and clips shown. The panel may then store only one type of bakery accessory, for example only nozzles or only bakery containers, or any combination of nozzles, nozzle adapters, nozzle adapter caps, bakery containers, bakery brushes and/or other bakery accessories.

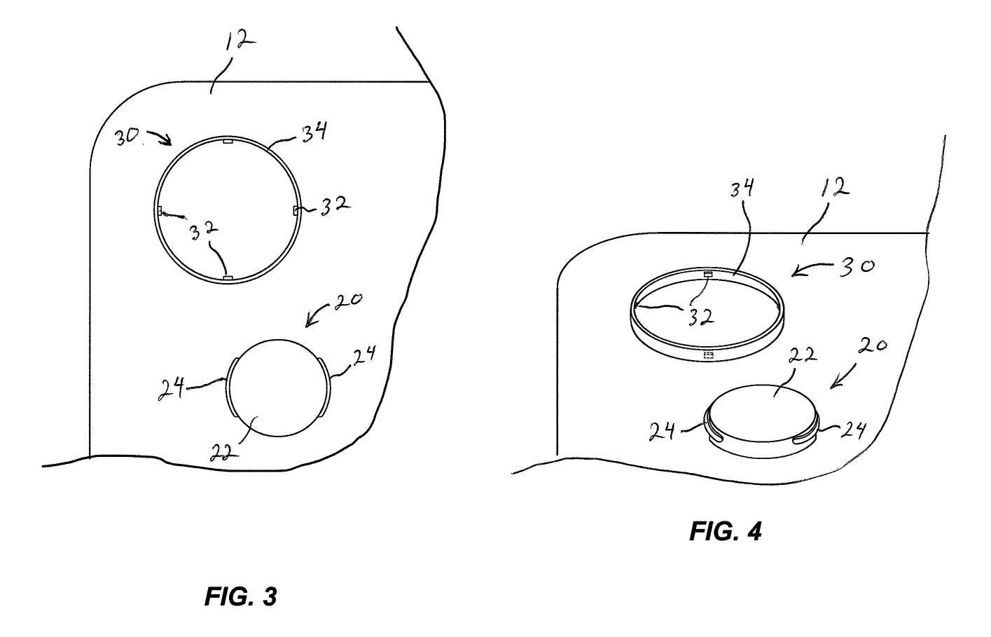

FIGS. 3 and 4 show an enlarged view of the panel protrusion 20 and nozzle adapter clip 30. The panel protrusions 20 include cylindrical body 22 and spiral or helical external threads or lips 24 extending outwardly from the cylindrical body 22 for securing the bakery accessory to the panel protrusion 20. The external threads are interrupted, that is, they do not extend continuously around the entire outer periphery of the body. Instead, they are spaced apart and each may extend for less than 180° or half of the periphery, about 75° as shown. The panel clip 30 includes a circular rim 34 extending upward from the panel base 12 and a plurality of spaced, separate and distinct rim protrusions 32 extending inwardly from the rim 34 engagable with a nozzle adapter 60. As shown, the four rim protrusions are spaced equally around the inner periphery of rim 34, but fewer or more may be employed.

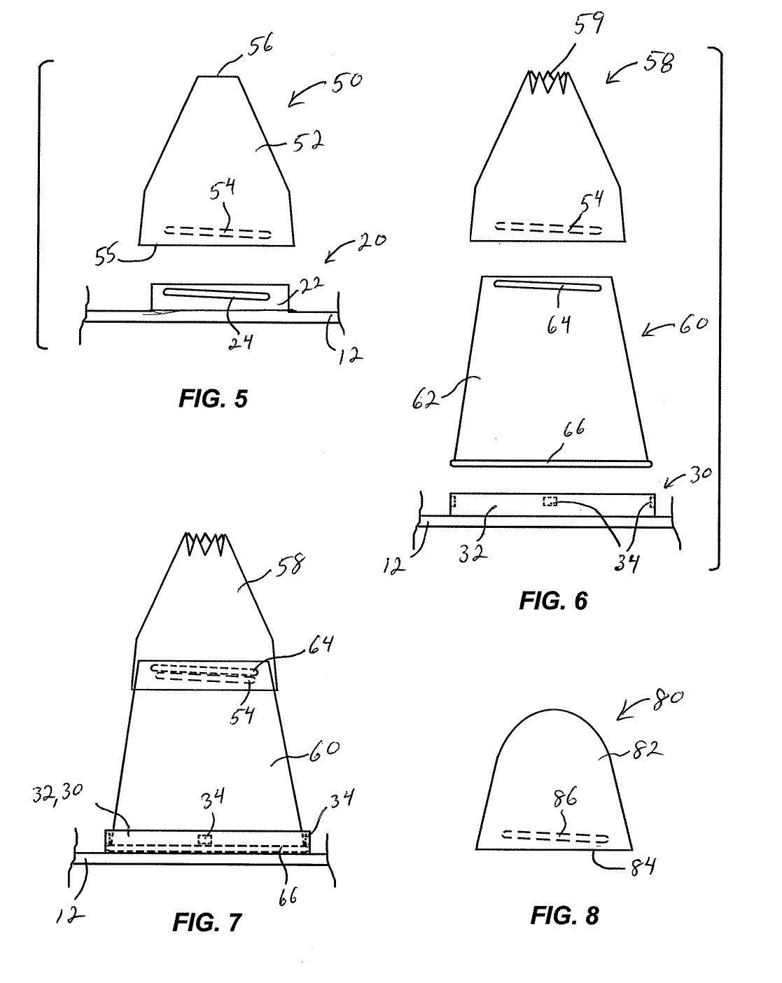

FIG. 5 shows the nozzle 50 having a tapered conical body 52, internal helical nozzle thread 54 engagable with the external projection 24 on the panel protrusion 20 and nozzle upper opening 56 which extends to the nozzle lower opening 55. Like the threads 24 of the panel protrusion, nozzle threads or lips 54 do not extend continuously around the entire inner periphery, and are instead spaced apart and each may extend for less than 90° or one-quarter of the periphery, about 75° as shown. The lower portion of nozzle 50 engages the complimentary panel protrusion 20 as the nozzle lower opening 55 is positioned and rotated on the cylindrical body 22 of the panel protrusion 20. Because of the interrupted threads 24, 54, the nozzle may be pushed straight onto the panel protrusion with the nozzle threads 54 aligned with the spaces between the panel protrusion threads 24 (and vice-versa), and the nozzle may be twisted less than one full turn (360°), for example, one-half turn, to secure it to the panel. To remove the nozzle, it is only necessary to twist it the same amount and pull it straight off the panel.

FIGS. 6 and 7 show a nozzle adapter 60 for associating a nozzle 58 with a bakery bag sleeve. The nozzle adapter 60 may include a frusto-conical body 62, interrupted external thread 64 on the upper portion of the adapter 60 and an outwardly extending adapter rim 66 along a bottom edge of the adapter 62. Nozzle 58 is removably attachable at its lower end to the nozzle adapter 60. The nozzle 58 may include interrupted internal nozzle thread 54 for attachment to complimentary adapter thread 64, and a serrated opening 59. The nozzle adapter rim 66 is engagable with the rim protrusions 34 on the circular rim 32 of nozzle adapter clip 30. Alternately, the nozzle adapter may include internal helical threads adjacent a lower portion of the nozzle adapter for attaching the nozzle adapter to a corresponding panel protrusion. FIG. 8 shows a nozzle adapter cap 80 which includes a cap body 82 having a bottom opening 84 with interrupted internal cap threads 86 engagable with complimentary adapter thread 64 or the interrupted external threads 24 of the panel protrusion 20. Nozzle 50 is also attachable to the nozzle adapter 60.

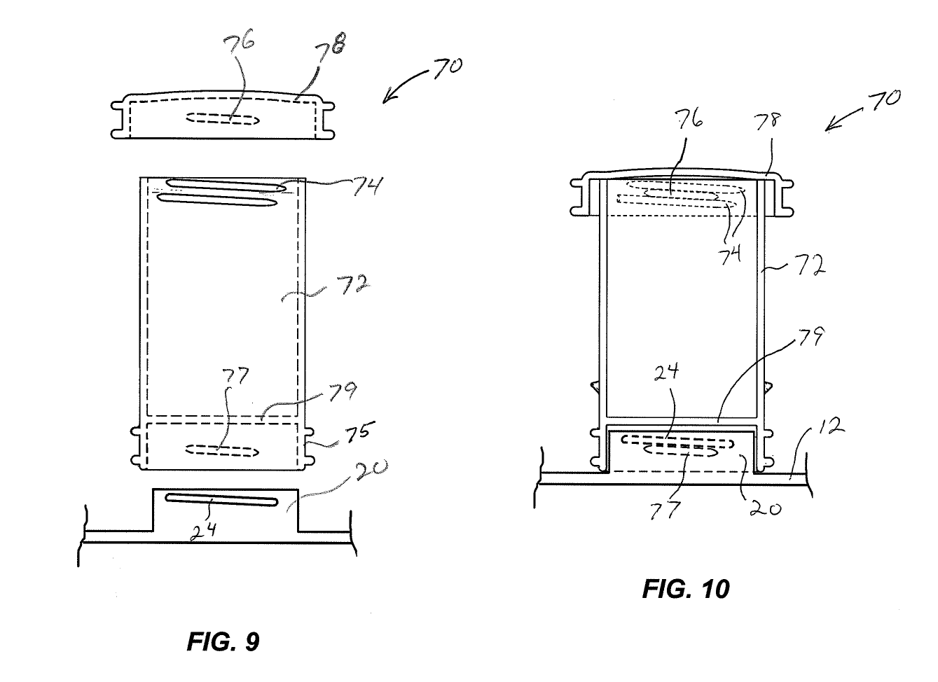

A bakery container 70 shown in FIGS. 9 and 10 may be used for storing small bakery decorating items such as sprinkles, confections and sugars. The container 70 includes a cylindrical container body 72, container cover 78, container bottom 79 and engagable base 75. The cover 78 includes internal cover threads 76 engagable with external container threads 74. The container base 75 includes internal interrupted base threads 77 engagable with the complimentary external threads 24 of the panel protrusion 20. Threads 77 are configured in the same manner as nozzle threads 54 discussed above, and container 70 may be pushed straight onto the panel protrusion with threads 77 in the spaces between protrusion threads 24, and the container may be twisted one-half turn or otherwise less than 360° to secure it to the panel. As before, to remove the container, it is only necessary to twist it the same amount and pull it straight off the panel.

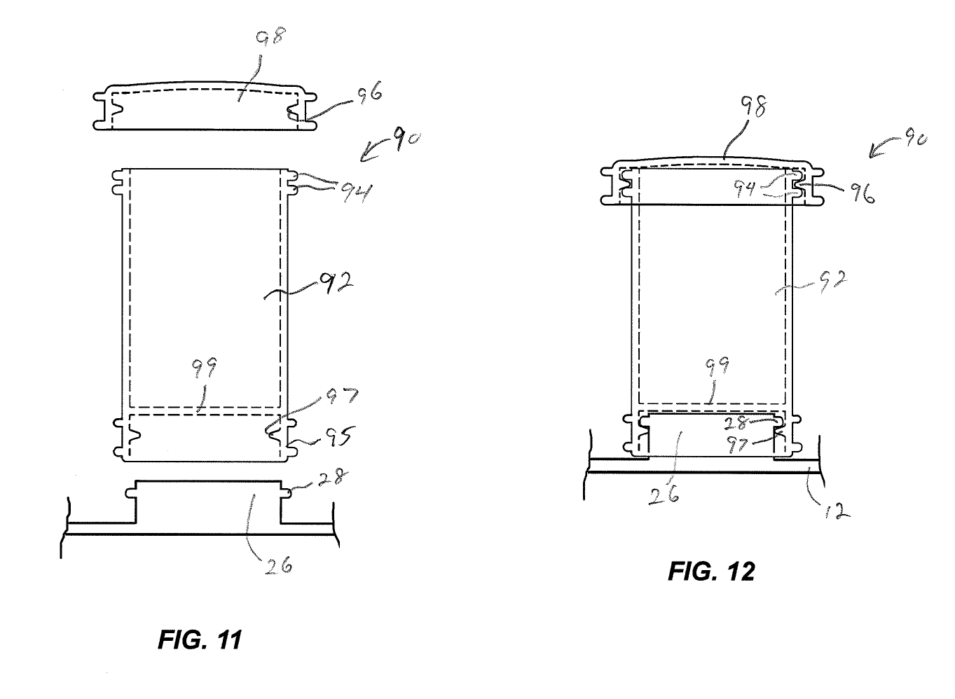

FIGS. 11 and 12 show a second embodiment of the bakery container attachable to a second embodiment of the panel protrusion. The bakery container 90 includes a cylindrical container body 92, container cover 98, bottom 99 and engagable base 95. The panel protrusion 26 includes an external lip 28 which is engagable with an internal lip 97 of the container 90, allowing the container base 85 to snap onto panel protrusion 26. Complimentary lips 28 and 97 may extend continuously around their respective peripheries or may be interrupted. The container cover 98 includes an internal cover lip 96 extending along the inside of the cover 98, the internal cover lip 96 engagable with a pair of upper body lips 94 extending around an upper portion of the container body 92. The container cover 98 may be snapped onto the container body 92 by urging the container cover 98 toward the container body 92 until the internal cover lip 96 engages the pair of upper body lips 94.

The panel protrusion 26 shown in FIGS. 11 and 12 may also be used on the nozzle panel for engaging nozzles, which would then have a lower opening with an inwardly protruding lip 97 rather than the previously described threaded protrusion for engaging the panel protrusion.

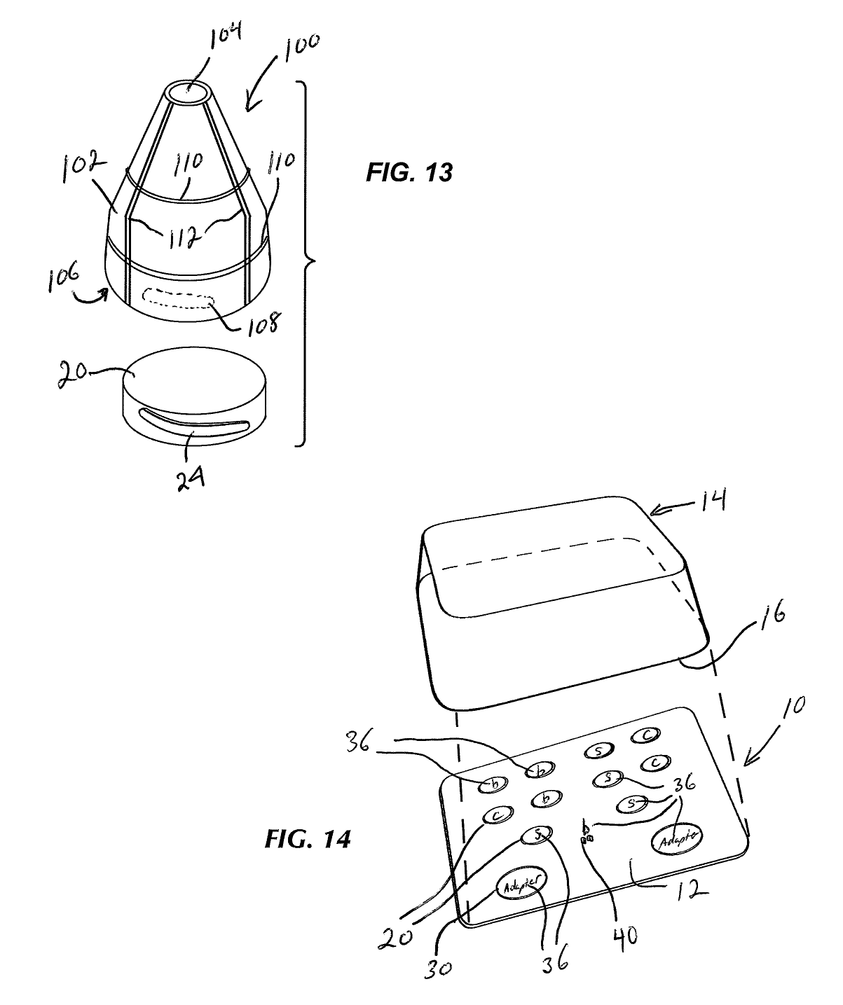

FIG. 13 shows a nozzle 100 having tapered body 102, upper opening 104, lower opening 106 and internal interrupted threads 108 (similar to threads 54) for attachment to a panel protrusion 20 having complimentary interrupted threads 24. The nozzle 100 also includes outwardly protruding rings 110 disposed along and around the outer circumference of the nozzle 100 and vertical elements 112 disposed on and extending along the length of the outer surface of the nozzle 100, the protruding rings 110 and vertical elements 112 providing greater structural integrity to the nozzle 100. The protruding rings 110 and vertical elements 112 may be used on any of the nozzles 50, 52, 58, bakery containers 70, 90 or nozzle adapter 60 described above.

The nozzle panels, nozzles and other bakery accessories of the present invention may be made of any suitable material, for example a food grade plastic or stainless steel. The panels may be injection molded or otherwise formed so that the base and protrusions are integrated.

FIG. 14 shows a perspective view of a nozzle panel cover 14 attachable to the nozzle panel base 12. The nozzle panel cover 14 may be transparent plastic, translucent plastic or opaque plastic and may be injection molded. The nozzle panel cover 14 may alternately be made of glass or a metal such as stainless steel or aluminum. The nozzle panel cover 14 includes a cover rim 16 along bottom portion of the nozzle panel cover 14. The nozzle panel cover 14 is removably fastenable to the panel base 12 along the periphery of the nozzle panel 10, for example, using the same type of engageable lips 94, 96 as between cover 98 and container 92, to permit the panel cover to snap on and off the base. The panel protrusions 20, nozzle adapter clips 30 or bakery brush clip 40 may include a marking, indicia or symbol 36 for designating placement of the nozzles and other bakery accessories. For example, “C” may designate container or “Adapter” may designate the location for the nozzle adapters. The marking may be placed on or adjacent the nozzle panel by etching, applying a marking ink, applying a sticker containing the marking or any other method which permanently applies the marking to the appropriate panel protrusion 20, nozzle adapter clip 30 or bakery clip 40.

In a method of using the nozzle panel, the steps include providing the nozzle panel as described above and providing a plurality of nozzles and/or other bakery accessories selected from the group consisting of nozzles, nozzle adapters, nozzle adapter caps, bakery containers and bakery brushes. The method includes initially engaging each of the plurality of nozzles, containers and other accessories with a panel protrusion 20 or panel clip 30 on the nozzle panel 10, as described above. After initial setup, the user then selects a nozzle or other bakery accessory to use in the preparation of food items, uses the item in the preparation of the food items and engages the nozzle or bakery accessory with the corresponding panel protrusion 20 or panel clip 30. The method may include washing and drying the nozzle or bakery accessory before engaging with the panel protrusion.

A method for using the bakery container 70 includes the user removing the container from the panel by twisting the container 70 in one direction from the panel protrusion 20, twisting the container cover 78 from the container body 72, removing a portion of the container contents, replacing the cover 78 onto the container body 72 and replacing the container 70 on the panel protrusion 20 by twisting the container 70 in the opposite direction. Initial setup of the nozzle panel may include filling the container with a baking product, placing the cover 78 onto the container body 72 and engaging the container 70 with one of the panel protrusions 20.

A method for using the second embodiment of the bakery container 90 includes the user removing the container from the panel by pulling the container 90 in one direction from the panel protrusion 26, urging the container cover 98 from the container body 92, removing a portion of the container contents, replacing the cover 98 onto the container body 92 and replacing the container 90 on the panel protrusion 26 by snapping the container 90 into the panel protrusion 26 until the internal lip 97 engages the external ring 28. Initial setup of the nozzle panel may include filling the container with a baking product, placing the cover 98 onto the container body 92 and engaging the container 90 with one of the panel protrusions 26.

In an alternate method of using the nozzle panel, the steps include providing a plurality of nozzle panels as described above and providing a plurality of nozzles and accessories selected from the group consisting of nozzles, nozzle adapters, nozzle adapter caps, bakery containers and bakery brushes. The method includes initially engaging each item in a first group on one of the nozzle panels with a panel protrusion 20 or panel clip 30. The method includes initially engaging each item in a second group on one of the nozzle panels with a panel protrusion 20 or panel clip 30. After initial setup, the user then selects a nozzle or other bakery accessory to use in the preparation of food items, uses the item in the preparation of the food items and engages the nozzle or bakery accessory with the corresponding panel protrusion 20 or panel clip 30.

Thus, the present invention provides a storage panel which stores and organizes bakery products such as nozzles, nozzle adapters nozzle adapter caps, small bakery containers and bakery brushes, and which provides for easy attachment to and removal from the storage panel. The storage panel may be mounted on a wall with screws, adhesive or adhesive tape. The panel may alternately be placed on a counter or in a drawer. Since the nozzles and nozzle adapters are removably fastened to the panel, the nozzles and nozzle adapters remain neatly on the panel during storage.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A nozzle panel for holding bakery accessories comprising:
a flat panel base;
a plurality of panel protrusions integral with the panel base, the panel protrusion having a lip engagable with a bakery accessory; and
at least one bakery accessory attachable to the panel protrusions on the flat panel base.

2. The nozzle panel of claim 1 wherein the panel protrusion lip is an interrupted helical thread attached to the panel protrusion whereby the at least one nozzle is engagable with the panel protrusion by twisting the nozzle relative to the panel base less than 360°.

3. The nozzle panel of claim 2 wherein the nozzle includes an inwardly extending interrupted helical thread adjacent a bottom edge of the nozzle and is rotatably engagable with the interrupted thread of panel protrusion.

4. The nozzle panel of claim 1 including at least one container attachable to the panel protrusion.

5. The nozzle panel of claim 4 wherein the container is cylindrical and includes a container opening at one end of the container and a removable lid engagable with the container opening.

6. The nozzle panel of claim 1 including at least one brush clip integral with the panel base and at least one bakery brush attachable to the brush clip.

7. The nozzle panel of claim 1 including at least one nozzle adapter clip and at least one nozzle adapter attachable to the nozzle adapter clip, the nozzle adapter clip including a circular rim extending upward from the panel base and rim protrusions extending inwardly from the rim whereby the nozzle adapter clip is engagable with the nozzle adapter.

8. The nozzle panel of claim 1 wherein the panel protrusion is cylindrical and includes a substantially flat upper surface and a cylindrical wall, the panel protrusion lip extending outwardly along the cylindrical wall adjacent the upper surface.

9. The nozzle panel of claim 8 wherein the nozzle includes an inwardly extending interrupted helical thread adjacent a bottom edge of the nozzle and is engagable with the panel protrusion.

10. The nozzle panel of claim 1 wherein the panel protrusion is cylindrical and includes an upper rim and a cylindrical wall, the panel protrusion lip extending outwardly along the cylindrical wall adjacent the upper rim.

11. The nozzle panel of claim 1 including a marking on or adjacent at least one of the panel protrusions for indicating which bakery accessory is designated for the at least one of the panel protrusions.

12. The nozzle panel of claim 1 including a marking on or adjacent each of the panel protrusions for indicating which bakery accessory is designated for each of the panel protrusions.

13. The nozzle panel of claim 1 including a nozzle panel cover engagable with the nozzle panel.

14. The nozzle panel of claim 1 including a lip on an edge of nozzle panel and on an edge of the nozzle panel cover whereby the nozzle panel cover may engage and snap on and off the edge to the nozzle panel.

15. A panel for holding bakery accessories comprising:
a flat panel base;
a panel protrusion integral with the panel base, the panel protrusion having a lip engagable with a bakery accessory; and
a panel clip integral with the panel base, the panel clip including a circular rim extending upward from the panel base and spaced rim protrusions extending inwardly from the rim engagable with a bakery accessory.

16. The nozzle panel of claim 15 wherein the panel protrusion lip is spirally attached to the panel protrusion whereby the bakery accessory is engageable with the panel protrusion by twisting the nozzle or nozzle adapter relative to the panel base less than 360°.

17. The nozzle panel of claim 15 further including at least one bakery container attachable to the panel protrusion.

18. The nozzle panel of claim 17 wherein the bakery container is cylindrical, has a container opening at one end of the container and a removable lid engagable with the container opening.

19. A method of using a bakery accessory panel comprising:
providing a bakery accessory panel for holding bakery accessories having a flat panel base, a plurality of panel protrusions integral with the panel base, the panel protrusion having a lip engagable with a bakery accessory;
providing any combination of a plurality of nozzles and accessories selected from the group consisting of nozzles, nozzle adapters, nozzle adapter caps, bakery containers and bakery brushes;
initially engaging each of the plurality of nozzles and accessories with a panel protrusion;
selecting a nozzle or accessory to use in the preparation of food items;
using the nozzle or accessory in the preparation of the food items; and
engaging the nozzle or accessory with the corresponding panel protrusion.

20. The method of claim 19 including washing and drying the nozzle or accessory before engaging with the panel protrusion.
